(19) United States
(12) Patent Application Publication
(10) Pub. No.: US 2005/0089705 A1
(43) Pub. Date: Apr. 28, 2005

(54) Assembly comprising at least one support with deposit of getter material for use in electroluminescent organic screens

(75) Inventors: Massimo della Porta, Milano (IT); Stefano Tominetti, Milano (IT)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: SAES GETTERS S.p.A.

(21) Appl. No.: 10/997,229

(22) Filed: Nov. 24, 2004

Related U.S. Application Data
(63) Continuation of application No. PCT/IT03/00324, filed on May 27, 2003.

(30) Foreign Application Priority Data
Jun. 3, 2002 (IT) MI2002A 001201

(51) Int. Cl. E06B 3/24

(52) U.S. Cl. 428/544; 428/43; 428/34

(57) ABSTRACT

An assembly (10; 20; 30) is formed of at least one support (11; 21; 31) with a deposit (13; 22; 33) of a getter material, to be used as back support of electroluminescent organic screens (known as OLEDs). The assembly provides provisional protection from atmospheric gases for the getter deposit until it is used in the screen. From the assembly is easily obtained a back support for OLEDs already having the getter deposit at the moment of use in the manufacture of these screens.

### CROSS-REFERENCE TO RELATED APPLICATIONS

This application is a continuation of International Application No. PCT/IT03/00324, filed May 27, 2003, which was published in the English language on Dec. 11, 2003, under International Publication No. WO 03/103069 A2 and the disclosure of which is incorporated herein by reference.

### BACKGROUND OF THE INVENTION

The present invention relates to an assembly comprising at least one support with a deposit of getter material for use in electroluminescent organic screens.

Electroluminescent organic screens are characterized by a very reduced thickness and are under development for use in stereo equipment (in particular for cars) or in cellular phones, and their use as television screens is also under study. These screens are better known in the field by the acronym “OLED” (from “Organic Light Emitting Diode”), which will be used in the rest of the description.

Very briefly, an OLED is formed of a first transparent, essentially planar support, generally made of glass or of a plastic polymer; a first row of transparent electrodes (generally made of ITO, a mixed tin- and indium-oxide), linear and parallel to each other deposited on the first support; a double layer of different electroluminescent organic materials, of which the first is a conductor of electrons and the second of electron vacancies, deposited on the first series of electrodes; a second series of electrodes (made generally of the alloys Al—Li or Al—Mg or with composite double layers, for example Al—LiF or Al—Li₂O), linear and parallel to each other and with orthogonal orientation with respect to the electrodes of the first row, contacting the upper part of the double layer of organic materials, so that the double layer is comprised between the two rows of electrodes; and a second, not necessarily transparent support, which can be made of glass, metal or plastics, essentially planar and parallel to the first support. The two supports are fixed to each other along their perimeter, generally by gluing, so that the active part of the structure (electrodes and electroluminescent organic materials) is in a closed space. The first transparent support is the portion wherein the image is visualized, whereas the second support has generally only the function of closure and backing of the device, in order to provide the device with a sufficient mechanical resistance.

The main problem noticed with these devices consists in that they rapidly lose their light-emission features following humidity sorption. The life of these devices is reduced from thousands or tens of thousands of hours in the absence of humidity, as experimentally verified in suitable chambers, to a few hours when exposed to the atmosphere. Even if the mechanisms of the OLED functional decay have not been completely clarified, it is probable that the phenomenon can be attributed on one hand to addition reactions of the water molecule to the unsaturated bonds of the organic component, and on the other hand to the reaction of water with the electrodes, in particular the metal cathodes. The main route for entrance of water into the OLEDs is the perimeter seal of the two supports, which is generally carried out by gluing with water-permeable epoxy resins, used by nearly all manufacturers. Water can additionally permeate through the supports themselves, in the case these are made of polymeric materials (always water-permeable, even if there are permeability differences among the various materials) or it can be released from the same organic materials of the electroluminescent double layer.

The solution of the problem caused by the entrance of water into an OLED is the subject-matter of various patent publications which propose different solutions.

U.S. Pat. Nos. 5,693,956 and 5,874,804 describe OLEDs for whose manufacture are employed inorganic materials impermeable to water, such as quartz or metals. Anyway, these systems do not solve the problem of the release of water by the materials which form the OLED.

International Publication WO99/03122 describes introducing into the OLED inner space gases, such as silanes, trimethylaluminum or triethylaluminum, which react quickly with the water molecules by generating reaction products harmless for the device functioning. However, this system has moderate applicability in industry.

U.S. Pat. Nos. 5,804,917 and 5,882,761 and International Publication WO99/35681 describe the use of humidity sorbing systems, but extremely vaguely, by simply indicating the use of a getter applied to the OLED second support, without either specifying the nature of the getter material or providing useful indications about the construction method of an OLED containing the getter material. International Publication WO98/59356 adds to the preceding documents a teaching about the kind of getter materials that may be used, by indicating for example the metals barium, lithium or calcium, or barium oxide.

However, even in this case, it is not explained how to deposit these materials in a stable way on the second support or how to reconcile the deposition of these layers with the manufacturing process of the OLEDs. As a matter of fact, the above listed materials are extremely reactive towards water and atmospheric gases and must be protected from the moment of the layer deposition until they are used. These layers could be deposited on the second support “in line”, i.e. as one of the OLED manufacturing process steps, but this possibility is not appreciated by screen manufacturers since it complicates the manufacturing process and requires the adoption of particular measures in treating extremely reactive elements.

The preferred solution by the OLED manufacturers would be receiving from external suppliers a humidity sorbing device, preferably in the form of a deposit on the second support, finished and ready for assembly with the first support on which the electroluminescent structure is already present. However, in this case there is the problem of preventing contact of the deposit with atmospheric gases for the whole period from the creation thereof up to the moment of use in the OLED. Considering also the required transport between different manufacturing sites, this implies the use of tight containers kept under inert atmosphere, with large increase of the manufacturing costs of the final screen.

### BRIEF SUMMARY OF THE INVENTION

An object of the present invention is to provide a support with a deposit of getter material ready for use in organic electroluminescent screens which overcomes the above mentioned storing and transporting problems.

This object is achieved according to the present invention by virtue of an assembly formed of at least one support in glass or metal whose border is fixed to a member impermeable to atmospheric gases, and having a deposit of an alkaline or alkaline-earth metal or an oxide of these metals in the central portion of the side of the support facing the impermeable member. Preferably, the impermeable member is a second support with a deposit of metal or oxide on the side facing the first support.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a in partially cut-away perspective view of an assembly according to the invention;

FIG. 2 is a cross-section view of an assembly according to a preferred embodiment of the invention; and

FIG. 3 is a partial detail view which represents a possible variation of the assemblies of FIGS. 1 and 2.

### DETAILED DESCRIPTION OF THE INVENTION

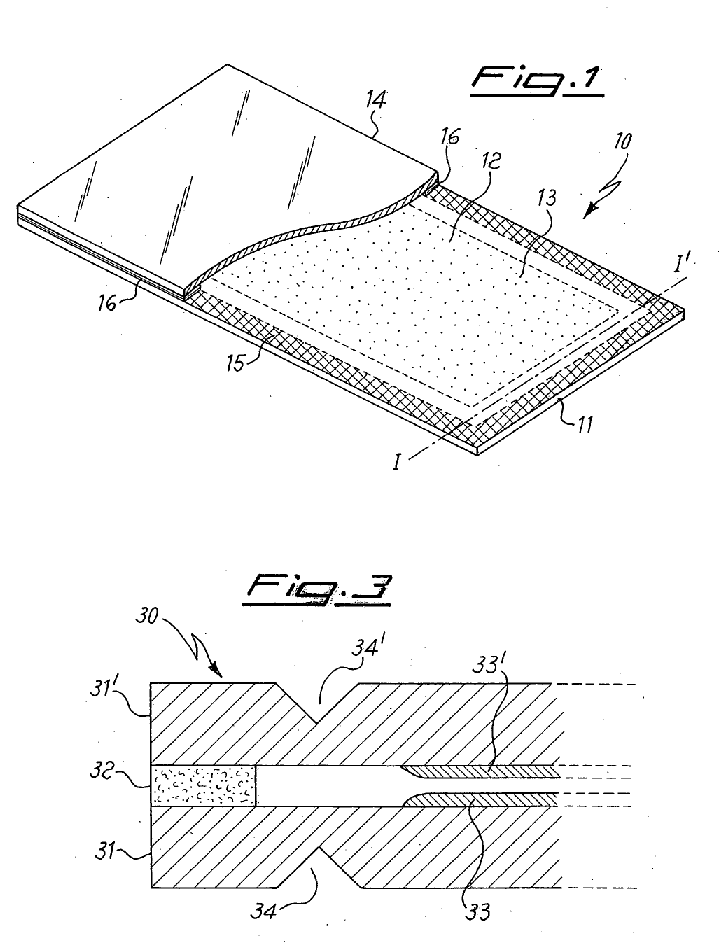

As shown in FIG. 1, the assembly 10 according to the invention is formed of two rigid members, essentially planar and impermeable to gases, fixed to each other in the peripheral zone thereof. At least one of the two members forms the support with getter material deposit to be used as the second support of the OLED. In FIG. 1 this support is shown as member 11. The support is provided in the central portion 12 thereof with a deposit 13 of a getter material selected among alkaline or alkaline-earth metals or the oxides thereof. The use of barium is preferred. Immediately after the production of deposit 13 on support 11, the latter is fixed to member 14 along a peripheral zone (drawn in hatched lines in FIG. 1 and identified as zone 15) by fixing means 16, which may be a weld in the case of metal members or a low-melting glass paste in the case of glass members. With this construction deposit 13 is found, right after its formation, in a sealed space not in contact with the outside, and in this condition it may be stored indefinitely or transported without requiring special containers. At the moment of use by the OLED manufacturer, it is sufficient to cut the assembly along lines comprised between zones 12 and 15 (one of these lines, I-I′, is exemplified in FIG. 1) in order to remove the protecting member 14 and have support 11 with deposit 13 ready for use as the second support of the OLED.

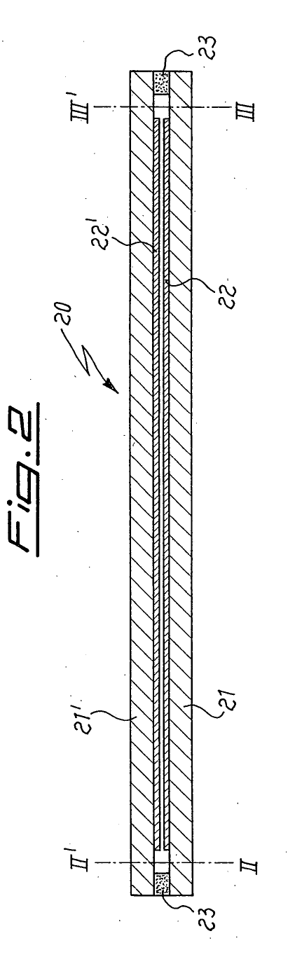

In a preferred embodiment, both members 11 and 14 of FIG. 1 are supports with getter material deposits to be used as second supports of an OLED. This configuration is shown in cross-(section in FIG. 2. Assembly 20 is formed of two supports 21 and 21′, each of which carries in the central portion of the side facing the other support a deposit 22, 22′ of one of the above mentioned getter materials. The two supports 21 and 21′ are fixed at the periphery thereof by fixing means 23, analogous to means 16 of assembly 10. In this case too, the OLED supports with getter deposit are obtained from assembly 20 by cutting along lines comprised between fixing means 23 and deposits 22, 22′, such as the lines II-II′ and III-III′ shown in FIG. 2. Assembly 20 is preferred with respect to the assembly of type 10, since in this case two supports for OLED are obtained from each assembly, thus doubling the productivity of the system.

FIG. 3 shows a constructive detail of the assemblies according to the invention which makes the use thereof easier. FIG. 3 exemplifies the case of an assembly of the type 20. FIG. 3 shows an enlarged view of the peripheral zone of the assembly 30 formed of two supports 31 and 31′, fixed to each other by fixing means 32, a deposit 33, 33′ of a getter material being provided on each of them. The two supports 31 and 31′ are provided with grooves, 34 and 34′, at the lines where subsequently the cuttings for separation thereof will have to be made (that is, at the lines I-I′, II-II′ and III-III′ of FIGS. 1 and 2). These grooves make easier the location of the cuttings for the separation of the two supports, and if sufficiently deep they can allow breaking by bending along the lines (in particular, in the case of glass supports 31 and 31′), thus making superfluous the use of cutting operations.

In the assemblies according to the invention the deposits of getter material (13; 22, 22′; 33, 33′) can be obtained by evaporation in the case of metal deposits, which can then be converted into oxide by exposure to an atmosphere of oxygen, pure or in an inert gas. Alternatively, it is possible to use the technique known with the name of “Physical Vapor Deposition”, more commonly indicated as “sputtering”, or its variant reactive sputtering, where the deposition step takes place in an argon atmosphere containing a small percentages of oxygen. These deposits generally have thickness values included between fractions of microns and a maximum of 10-20 microns.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An assembly (10; 20; 30) comprising two rigid members (11,14; 21,21′;31,31′), the rigid members being essentially planar and impermeable to atmospheric gases, fixed to each other in a peripheral zone thereof and defining a sealed space, at least one of the members having thereon a deposit (13; 22; 33) of an alkali metal, alkaline earth metal or an oxide of these metals in a central portion (12) of a side of the member facing the sealed space, wherein the at least one member having the deposit comprises glass or metal, and wherein the sealed space is kept under vacuum or an atmosphere of a gas inert to the deposit.

2. The assembly according to claim 1, wherein the rigid members are made comprise glass and are fixed to each other by a low-melting glass paste.

3. The assembly according to claim 1, wherein the rigid members comprise metal and are fixed to each other by welding.

4. The assembly according to claim 1, wherein the deposit comprises barium.

5. The assembly according to claim 1, wherein the rigid members have grooves (34, 34′) adjacent the peripheral zone along weakening lines (I-I′; II-II′; III-III′) for separation of the rigid members.

6. The assembly according to claim 1, wherein the at least one rigid member having the deposit forms a back support for an OLED when separated from the assembly.
